(19) United States
(12) Patent Application Publication
(10) Pub. No.: US 2004/0101945 A1
(43) Pub. Date: May 27, 2004

(54) Method and system for plant/bacterial phytoremediation

(76) Inventors: William Wayne Bogan, Palatine, IL (US); James Robert Paterek, Naperville, IL (US); Vipul J. Srivastava, Woodridge, IL (US)

Correspondence Address: Mark E. Fejer, Gas Technology Institute, 1700 South Mount Prospect Road, Des Plaines, IL, 60018, US

(21) Appl. No.: 10/304,651

(22) Filed: Nov. 26, 2002

(51) Int. Cl. C12S 1/00; C02F 3/32

(52) U.S. Cl. 435/262.5; 210/602

(57) ABSTRACT

A method and system for phytoremediation of materials contaminated with organic pollutants in which at least one host plant is planted in the material and at least one microorganism capable of degrading at least one of the organic pollutants and enhancing germination, growth and/or survival of the at least one host plant is introduced into the materials.

### BACKGROUND OF THE INVENTION

1. Field of the Invention

This invention relates to phytoremediation as a treatment technology for reducing contaminants in soils and sediments. More particularly, this invention relates to a method and system for phytoremediation of materials contaminated with organic pollutants, such as PAHs, using a combination of plant and bacterial components, which operate in a synergistic manner to reduce the level of organic pollutants in the contaminated materials. In addition, the method and system of this invention employ a combination of plant and bacterial components, each of which is capable of enhancing one or more characteristics of the other component.

2. Description of Related Art

The term “phytoremediation” encompasses several approaches and mechanisms, all of which center around using living plants and the microbial ecosystem which their presence creates and supports to cleanse contaminated soils and other media, such as sediments, sludge and wastewater. The more common mechanisms and phenomena utilized for phytoremediation include phytoextraction in which pollutant compounds are taken up from the soil with concomitant concentration in above-ground plant tissues; rhizosphere biodegradation in which bacteria and fungi which naturally occur in the zone of soil immediately surrounding the plant root system (the rhizosphere) break down the contaminant(s) of interest, either as a source of carbon and energy or fortuitously during the metabolism of other compounds (co-metabolism); phytotransformation in which the plants themselves catalyze the degradation of contaminants; and phytostabilization in which plants with large, dense root systems stabilize the soil in place, thereby preventing runoff and/or erosion.

The relative advantages and disadvantages of phytoremediation as a site-remediation option are well known to those skilled in the art. (See, for example, Qiu et al, “Grass-Enhanced Bioremediation for Clay Soils Contaminated with Polynuclear Aromatic Hydrocarbons”, America Chemical Society Symposium Series V563, 563: 142-157, 1994; Schnoor, “Phytoremediation,” GWRTAC Technology Evaluation Report TE-98-01, Ground-Water Remediation Technologies Analysis Center, Pittsburgh, Pa., 1997; and Flathman et al., “Phytoremediation: Current Views on an Emerging Technology,” Journal of Soil Contamination, 7:415-432, 1998). Strengths and advantages of phytoremediation as a treatment technology include 1) in-situ application, requiring minimal site disruption, transport of contaminated material, etc.; 2) low cost; 3) depth of treatment—prairie grass root systems extend to 10-foot depths while those of phreatophyte trees can extend to 30 feet; 4) negligible air emissions; 5) use of dense-growing species (e.g. turfgrasses), which provides a “cap” of sorts, limiting exposure to soil during treatment; 6) use of naturally available energy (i.e. sunlight) and plant-influenced biological, chemical and physical processes, with minimal manipulation (fertilizer, irrigation) required; 7) aesthetic appeal, both to communities and regulatory agencies; and 8) co-cultivation of multiple plants, which could address a variety of contaminants (e.g. organics and metals).

Weaknesses attributed to phytoremediation as a treatment technology include 1) the frequent need for multiple growing seasons to reduce contaminants to an acceptable level; 2) difficulty of finding plants tolerant of toxic contaminated soils; and 3) the potential for contaminants to be taken up into aboveground biomass and enter the food chain through herbivore grazing. Although this last issue is primarily a concern with metals, some organic contaminants (mainly solvents) can also partition into the above-ground tissues of plants, which creates the risk of exposure of other ecoreceptors.

The ability of various soil bacteria, referred to as plant growth promoting rhizobacteria, to foster the growth of plants has already been demonstrated by those skilled in the art. Most of the work involved crop species, for example, winter wheat, cucumber, maize and soybeans. Bacteria which have been studied include species of Pseudomonas, Burkholderia and Bacillus and have been shown and/or postulated to exert their growth-enhancement effects through a variety of mechanisms including: 1) aid in plant iron uptake through production of siderophores; 2) antagonism of pathogens via antibiotics, lytic enzymes, and siderophores; 3) stimulation of root proliferation by production of analogs of plant hormones; and 4) aid in uptake of P or other nutrients.

It is also well known that the rhizosphere microorganisms, both bacteria and fungi, are important in the degradation of organic pollutants. For example, in the case of polynuclear aromatic hydrocarbons (PAHs), rhizospheres of several plant species have been shown to contain considerably higher levels of PAH-degrading bacteria than in surrounding soils. Populations of PAH-degraders in rhizosphere soil can be 1000-fold higher per gram of soil than in soil outside the zone of influence of roots. This has been documented with several grass species. In cases of some plants, this is most likely not due to the selection per se, but rather results from higher population densities of a wide range of bacteria. However, it is also known that some species of plants, for example mulberry, osage orange and apple, produce root exudate components, such as phenols, flavonoids and coumarins, which select for and stimulate bacteria with PAH-degrading capabilities. For example, a selective enrichment of phenanthrene degraders in the rhizosphere of slender oat is known, and grasses have been shown to specifically “recruit” endophytic bacteria with contaminant-degrading phenotypes in response to exposure to contaminated soils.

Laboratory scale studies have shown the ability of plants and/or their associated rhizosphere microbes to degrade polycyclic aromatics. In these studies, the removal of four PAHs (benz[a]anthracene, chrysene, benzo[a]pyrene and dibenz[a,h]anthracene) in soils planted with a mixture of eight common species of prairie grass was examined. The removal of all compounds was greater in planted microcosms than in unvegetated units and removal of the two four-ring compounds was more extensive than that of the two five-ring PAHs.

Other studies have shown similar results. For example, phenanthrene was degraded significantly faster in soil planted with slender oat than in bulk, non-rhizosphere soil, although the net increase in degradation rate was less than would be expected given the observed increases in the populations of phenanthrene degrading bacteria in rhizosphere soil. When phenanthrene (100 ppm) was spiked into a sandy loam soil, the extent of mineralization was 37% in two weeks in the presence of crested wheatgrass versus 7% in non-planted control soils. Nine plant species comprising grains, vegetable crops and evergreen trees, were tested with greater removal of pyrene in systems planted with each than in control microcosms. The magnitude of this effect was often very significant, with up to a two-fold increase in pyrene removal from vegetated microcosms in as short a time frame as eight weeks. The ability of perennial ryegrass to remediate PAH-contaminated soils has been assessed in greenhouse trials with soil columns. In these trials, three treatments were compared—planted soil amended with fertilizers and pH adjusters, planted non-amended soil and non-planted non-amended soil. During the one year course of the trials, all treatments showed significant removal of most PAHs with four or fewer rings, as well as some five-ring species. When the treatments were compared, rates of removal of pyrene, fluoranthene, chrysene and benzo[k]fluoranthene were shown to be highest in the plant amended soil. Several important PAHs from a regulatory standpoint, including benzo[a]pyrene, were resistant to treatment and others, most notably dibenz[a,h]anthracene, were not discussed.

Research has shown that the optimal function of this type of system requires the continued presence of live host plants, indicating that rhizosphere-adapted bacteria do not persist (at least not at such high levels) in the absence of live roots. In one such study, rhizosphere soils from grasses initially had considerably higher populations of PAH-degrading bacteria than were found in non-planted control soils. However, when the soils were removed from the influence of the plant and placed in slurry cultures, phenanthrene mineralization in the different soils was not statistically different. These results corroborated earlier tests which showed that degradation of pyrene and anthracene in soil removed from alfalfa rhizospheres was no greater than in non-sterile bulk soil.

Limited research by other groups has shown that pollutants-degrading rhizobacteria can foster plant growth in contaminated soils by reducing soil phytotoxicity. For example, the ability of a pentachlorophenol-catabolizing Pseudonmonas strain to protect proso millet in PCP-contaminated soil has been demonstrated. Bacterial seed inoculants which increased seed germination in chlorobenzoic acid-contaminated soils were found to slightly increase the degradation of these contaminants in the soil, either by plants, by other rhizosphere microbes, or both. This system was further refined through co-inoculation with plant growth promoting rhizobacteria and chlorobenzoic acid-degrading strains.

### SUMMARY OF THE INVENTION

It is one object of this invention to provide a method and system for phytoremediation of materials contaminated with organic pollutants that reduces or eliminates the requirement of conventional methods and systems for multiple growing seasons to reduce contaminants to an acceptable level.

It is another object of this invention to provide a method and system for phytoremediation of materials contaminated with organic pollutants which addresses the difficulty of finding plants tolerant of toxic contaminated soils.

It is still another object of this invention to provide a method and system for phytoremediation of materials contaminated with organic pollutants that reduces the potential for contaminants to be taken up into aboveground biomass and enter the food chain through herbivore grazing.

It is a further object of this invention to provide a method and system for phytoremediation of materials contaminated with organic pollutants in which degradation is accomplished using a single strain of bacterium in contrast to known methods and systems which require multiple strains of bacteria.

These and other objects of this invention are addressed by a system for phytoremediation of organic-contaminated materials, the system comprising at least one host plant disposed in the organic-contaminated materials and at least one microorganism capable of degrading at least one of the organic contaminants and enhancing germination, growth and/or survival of the at least one host plant, which at least one microorganism is also disposed in the material.

In accordance with the method of this invention, at least one host plant is planted in the organic-contaminated materials and at least one microorganism, which is capable of degrading at least one of the organic pollutants and enhancing the germination, growth and/or survival of the at least one host plant, is introduced into the organic-contaminated material.

The method and system of this invention help to address all of the above-listed shortcomings of conventional methods and systems. Selected, naturally-occurring bacteria, which simultaneously degrade organic pollutants and enhance the germination, growth, survival, and/or health of the host plant, are incorporated into rationally-designed plant/microbial hybrid phytoremediation systems. Contaminants are degraded more rapidly in these hybrid systems than with either component (plants or bacteria) alone, as a result of which the overall process requires less time to achieve a given cleanup level. Because the action of the bacteria, by accelerating the degradation of potentially phytotoxic contaminants, more rapidly reduces the overall toxicity of the soil, the issue of plant tolerance to contaminants is at least partially obviated. Finally, the fact that the contaminants are more rapidly and extensively degraded in the hybrid system helps to reduce the potential for transport of the contaminant(s) into above-ground plant tissues.

### BRIEF DESCRIPTION OF THE DRAWINGS

These and other objects and features of this invention will be better understood from the following detailed description taken in conjunction with the drawings wherein:

FIG. 1 is a diagram showing the system of this invention;

FIGS. 2A, 2B and 2C are diagrams showing inverse correlations between total heterotrophic bacterial populations of bacteria in soil microcosms and alfalfa seedling growth, total root mass and average (wet) root mass, respectively (implying that control of other bacteria is involved in plant growth enhancements caused by GTI-1 and GTI-7); and

FIGS. 3A, 3B and 3C are diagrams showing the results of various treatments of soils, specifically removal of phenanthrene, pyrene and fluoranthene, respectively, from coal-tar contaminated soil.

### DETAILED DESCRIPTION OF THE PRESENTLY PREFERRED EMBODIMENTS

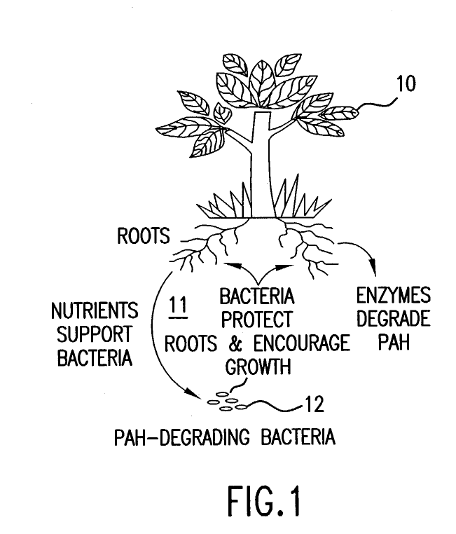

The present invention makes use of two individual biological elements: A) one or more host plants, preferably with inherent enzymatic capabilities for contaminant degradation and B) bacteria which simultaneously enhance the growth and/or survival of these plants while further contributing to the degradation of the target contaminants. The combination of these elements into the system of this invention is characterized by symbiotic relationships between the two elements, in which the host plant fosters growth and proliferation of contaminant-degrading bacteria. These contaminant-degrading bacteria, in turn, through mechanisms such as suppression of bacterial and fungal pathogens, promote the growth of plant roots, and enhance the overall health of the plant. Such a system is shown diagrammatically in FIG. 1. The system comprises at least one host plant 10 disposed in the organic-contaminated materials 11 and at least one microorganism 12 capable of degrading at least one of the organic contaminants and enhancing at least one of germination, growth and survival of the at least one host plant, also disposed in the materials 11. This system is particularly well-suited to the remediation of soils and other matrices contaminated with PAHs. A vast number of bacterial strains are known which are capable of degrading PAH, either as sole sources of carbon or energy, or cometabolically during growth on other substrates. Also, several plant species, including alfalfa and wheat, are known to produce enzymes which are known to oxidatively degrade PAHs. The key to this invention is a combination of bacterial strains and plant species which have a symbiotic relationship.

We have identified several PAH-degrading bacteria, mostly from the genera Burkholderia and Sphingomonas, which are able, when inoculated into soil seeded with alfalfa, to serve as promoters of plant germination, survival, and/or growth. The magnitudes of these effects were in many cases comparable to, or greater than, those seen when known plant growth-promoting strains, such as those which are used in agricultural applications, were inoculated into alfalfa rhizospheres in parallel microcosms.

Bacteria were isolated from PAH-contaminated soils by sublimating individual PAHs, most often phenanthrene or pyrene, onto gel plates, and isolating colonies capable of producing clearing zones. All isolates were then identified to the genus, and where possible, species level by ribosomal 16s rRNA gene sequencing and comparison with known sequences in the GenBank database. Designations for three of the PAH-degrading strains suitable for use in this invention are shown in Table 1.

TABLE 1

| Strain Designation | Genus | Closest Species Match | % Match |
|---|---|---|---|
| GTI-1 | Burkholderia | Clone WR1141 | 99% |
| (ATCC PTA-4755) | | | |
| GTL-2 | Burkholderia | B. phenazinium | 98+% |
| (ATCC PTA-4756) | | | |
| GTI-7 | Sphingomonas | S. yanoikuyae | 97% |
| (ATCC PTA-4757) | | | |

Preparation of liquid-culture bacterial inocula for use in the method and system of this invention was carried out as follows:

Mineral salts medium (MSM) consisting of the following components, in mg 1⁻¹: (NH₄)₂SO₄ (1000). K₂HPO₄ (800), KH₂PO₄ (200), MgSO₄ 7H₂) (200), CaCl 2H₂O (100), FeCl₃ 6H₂O (5) and (NH₄)₆Mo₇O₂₄ 4H₂O (1) was prepared. The pH was to 7.0, and the media was filter sterilized. Liquid cultures of PAH-degrading bacteria were established in 50 ml of MSM by inoculating with a loopful of bacteria obtained from R2A agar plates. These were supplemented with a small amount (5-10 mg) of phenanthrene, which was added in crystalline form. To each of the known PGPR stains, none of which were capable of phenanthrene degradation, based on screening on phenanthrene-sublimated plates, a similar amount of glucose was added as a carbon source. Flasks were incubated, with shaking, at room temperature. After 4-5 days, aliquots of each culture were read at (λ=600 nm) in a 96-well plate reader (Dynex Technologies, Chantilly, Va.) to determine absorbance values and to thereby ensure that the same number of bacteria was added to each microcosm. All bacterial suspensions were diluted with MSM or concentrated via centrifugation as necessary to reach an absorbance (A₆₀₀) of 0.08-0.10. To ensure that this procedure in fact yielded suspensions with equal numbers of viable CFU's per unit volume, appropriate dilutions (10⁻⁶-10⁻⁸) were plated on R2A agar, and colonies were counted after three days. Such calibrations showed that all of the suspensions contained between 3.2×10⁹ and 4.0×10⁹ colony-forming units ml⁻¹ at this A₆₀₀, with the exception of Pseudomonas aeruginosa R75, which had a cell density of 7.9×10⁸ CFU ml⁻¹.

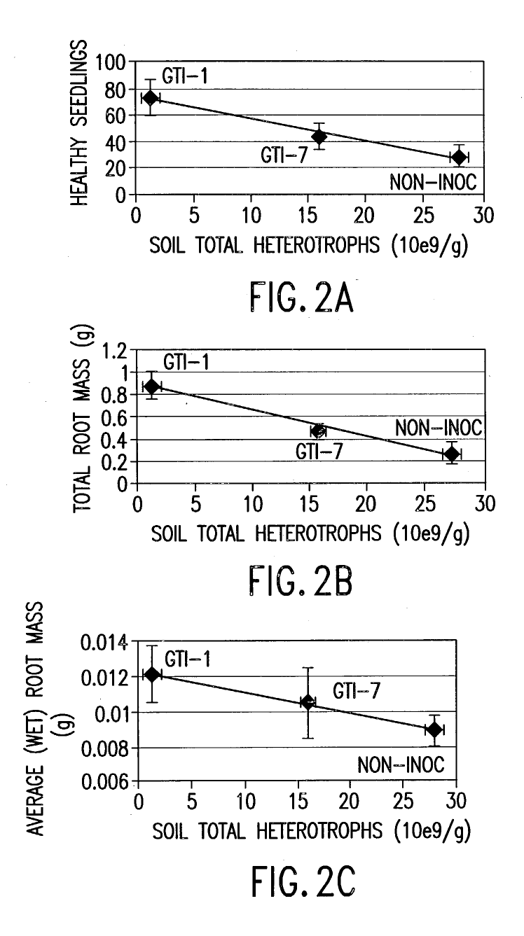

Data which we have obtained thus far indicates that the PAH-degrading bacteria primarily exert their effects by suppressing pathogenic (bacterial or fungal) attack on seeds and seedlings. For example, we have never observed any statistically significant enhancement of germination efficiency, or of root biomass development, under otherwise-axenic (sterile) conditions. In one set of experiments, conducted in a non-sterile test soil, the degree to which alfalfa growth was promoted showed a strong correlation with the total heterotrophic bacterial population of the microcosm soil, indicating that inoculation with the PAH-degrading bacteria suppressed proliferation of one or more other species, which may otherwise have had a detrimental effect on the health of the plant. In this experiment, alfalfa survived and grew best when inoculated with an isolated strain of Burkholderia ATCC No. PTA-4755 followed by a Sphingomonas strain ATCC No. PTA-4756. The inoculation of both strains resulted in increases in the number of healthy seedlings and root biomass (total root mass per microcosm and average mass per root). The magnitudes by which these parameters were increased, along with the corresponding beterotrophic bacterial populations, are shown in FIGS. 2A, 2B and 2C.

When seedlings were challenged to grow in soils infested with known pathogenic fungi (Fusarium oxysporum and Rhizopus nigricans), the deleterious effects of these fungi could be partially overcome by inoculation with several of the individual PAH-degrading bacterial strains. Given that the strains of Burkholderia and Sphingomonas used in these experiments showed some ability to repress and/or antagonize growth both of other bacteria and of fungi, it appears that the two strains may most likely produce a broad-spectrum antibiotic, or that they induce systemic resistance within the host plant to a range of pathogens. Bacterial production of siderophores, compounds which increase the availability of soil iron for uptake by the host plant, may also be involved in this process.

### EXAMPLE

Topsoil was spiked with coal tar, at the rate of 1000 parts per million, by dissolving tar in methylene chloride, and adding to soil with extensive mixing. After spiking, the soil was left uncovered in a fume hood for ca. 24 hours to provide ample time for volatilization of the methylene chloride, and was then used to establish microcosms. The above treatment resulted in soil with an initial total PAH concentration of ˜250 ppm. Microcosms receiving Burkholderia (ATCC PTA-4755) or Sphingomonas (ATCC PTA-4757) were inoculated with a suspension of these bacteria in liquid medium; mock-inoculated controls received an equal amount of medium with no bacteria. After three weeks, soil samples from each microcosm were soxhlet extracted (24-hour extraction with 1:1 acetone:methylene chloride); the extractants were then evaporated to dryness under a stream of N₂, redissolved in methylene chloride (1 ml), and analyzed by GC/MS.

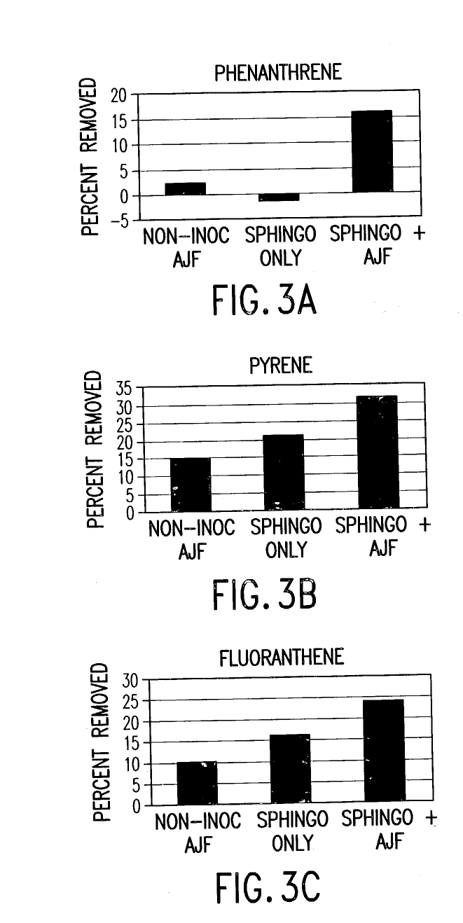

Recoveries of three model PAHs (phenanthrene, fluoranthene, and pyrene) during short (3-week) PAH phytoremediation trials of this nature are shown in FIGS. 3A, 3B and 3C. Very little loss of phenanthrene (relative to controls) occurred in either the planted or Sphingomonas-inoculated microcosms; the former of these is not surprising, as phenanthrene is probably a poor substrate for PAH-degrading enzymes which are produced by alfalfa. In contrast, some loss of two four-ring PAHs, pyrene and fluoranthene, did occur in both the alfalfa-only and Sphingomonas-only microcosms. For all three PAHs, the microcosms in which the two treatments were combined (Sphingomonas+alfalfa) showed lower PAH recoveries than those seen with either the bacteria or seedlings alone. When this data is expressed in terms of percentages of PAH removed (relative to mock-inoculated controls), the relative effects of the different treatments are more clear as shown in FIGS. 3A, 3B and 3C.

The case of phenanthrene in this experiment is most intriguing and exceptional, and best illustrates the benefits of this approach for phytoremediation. Although all three of these model PAHs were degraded to a greater extent in the alfalfa/Sphingomonas microcosms than in systems containing either component alone, the effect in the case of phenanthrene is clearly synergistic; that is, removal of this PAH in the combined treatment is considerably greater than the sum of removals in the individual (plant and bacterial) treatments.

While in the foregoing specification this invention has been described in relation to certain preferred embodiments thereof, and many details have been set forth for the purpose of illustration, it will be apparent to those skilled in the art that the invention is susceptible to additional embodiments and that certain of the details described herein can be varied considerably without departing from the basic principles of this invention.

We claim:

1. A method for phytoremediation of materials contaminated with organic pollutants comprising the steps of:
planting at least one host plant in said material; and
introducing at least one microorganism into said material, said at least one microorganism being capable of degrading at least one of said organic pollutants and enhancing at least one of germination, growth and survival of said at least one host plant.

2. A method in accordance with claim 1, wherein said material is selected from the group consisting of soil, sludge, sediment, wastewater and mixtures thereof.

3. A method in accordance with claim 1, wherein said at least one host plant is capable of degrading said at least one organic pollutant.

4. A method in accordance with claim 1, wherein said at least one microorganism is selected from the group consisting of Burkholderia strains, Sphingomonas strains and mixtures thereof.

5. A method in accordance with claim 4, wherein said at least one microorganism is selected from the group consisting of Burkholderia ATCC No. PTA-4755, Burkholderia ATCC No. PTA-4756, Sphingmonas ATCC No. PTA-4757 and mixtures thereof.

6. A method in accordance with claim 1, wherein said at least one organic pollutant comprises at least one PAH.

7. A method in accordance with claim 1, wherein said at least one host plant produces at least one enzyme suitable for oxidatively degrading PAHs.

8. A method in accordance with claim 1, wherein said at least one host plant is selected from the group consisting of alfalfa and wheat.

9. A method in accordance with claim 1, wherein an amount of said organic pollutants removed from said material by said at least one host plant and said at least one microorganism together is greater than a sum of said amount of organic pollutants removed by said at least one host plant on selected to said at least one microorganism individually.

10. A method in accordance with claim 6, wherein said at least one PAH is selected from the group consisting of phenanthrene, fluoranthene, pyrene and mixtures thereof.

11. A system comprising:
at least one host plant disposed in a material contaminated with at least one organic pollutant; and
at least one microorganism capable of degrading said at least one organic pollutant and enhancing at least one of germination, growth and survival of said at least one host plant disposed in said material.

12. A system in accordance with claim 11, wherein said at least one microorganism is selected from the group consisting of Burkholderia strains, Sphingomonas strains and mixtures thereof.

13. A system in accordance with claim 12, wherein said at least one microorganism is selected from the group consisting of Burkholderia ATCC No. PTA-4755, Burkholderia ATCC No. PTA-4756, Sphingmonas ATCC No. PTA-4757 and mixtures thereof.

14. A system in accordance with claim 11, wherein said at least one host plant is capable of degrading said at least one organic pollutant.

15. A system in accordance with claim 13, wherein said at least one organic pollutant comprises a PAH.

16. A system in accordance with claim 11, wherein said at least one host plant produces at least one enzyme suitable for oxidatively degrading PAHs.

17. A system in accordance with claim 11, wherein said at least one host plant is selected from the group consisting of alfalfa and wheat.
